(19) United States
(12) Patent Application Publication
(10) Pub. No.: US 2004/0073432 A1
(43) Pub. Date: Apr. 15, 2004

(54) Webpad for the disabled

(76) Inventor: Christopher J. Stone, Newtown, PA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/271,148

(22) Filed: Oct. 15, 2002

(51) Int. Cl. G10L 21/00

(52) U.S. Cl. 704/275

(57) ABSTRACT

A webpad is a wireless remote control unit that can be used to access the Internet and control, for example, a television set. The webpad also incorporates the ability to convert text data to voice data and vice versa. Consequently, a disabled user can use the webpad to communicate regardless of whether the user has a hearing or speech impediment. The webpad can replace traditional text telephone (TTY) devices. The webpad can also include fingerprint recognition capability to allow a disabled user to readily enter a secured identification for authorizing electronic transactions.

### FIELD OF THE INVENTION

The present invention relates to the field of communication devices for the disabled. More particularly, the present invention relates to a method and system allowing a disabled user to carry on TTY communication using a multi-functional webpad.

### BACKGROUND OF THE INVENTION

Traditionally, many people with disabilities have communicated over extended distances using a text telephone (TTY). As used herein, a TTY is a special device that allows deaf, hearing impaired, speech-impaired, or other similarly disabled users to employ a text telephone to communicate, by allowing them to type messages back and forth to one another over a phone line instead of talking and listening.

To use a TTY, a user types the desired message on the TTY's keyboard. As the user types, the message is sent over the telephone line just as a voice signal would be sent over that same telephone line. Some TTY models can be plugged directly into a standard telephone line others require specialized or dedicated connections. This technology has not changed significantly since its implementation. In most present applications, a TTY device is required at both ends of a conversation in order to communicate. In most cases, each user can read the other communicating users message on a text display.

A TTY user and non-TTY user may still be able to communicate, however. Such a communication requires calling a special number to use the telecommunications relay service (TRS). With TRS, a special operator will act as a translator so that a TTY user can receive message from the non-TTY users on his or her TTY display. The TTY user may then type back a response, which the TRS operator will read aloud over the phone to the non-TTY user.

While the TTY system provides a means for communication to users who would otherwise have difficulty using a standard telephone, the TTY system has some drawbacks. Unfortunately, in many cases, users may be required to pay additional fees for TTY support from their local telephone company or to get a separate or dedicated TTY line. TTY machines are often expensive and in most cases offer only one practical application. In some cases a user may forget the number to access the TRS system or similar service. Many users feel the process is too slow and error prone. Additionally, some users feel a lack of privacy and security when using a TRS operator to communicate.

### SUMMARY OF THE INVENTION

In one of many possible embodiments, the present invention provides a webpad, which is a wireless remote control unit that can be used to access the Internet and control, for example, a television set. The webpad also incorporates the ability to convert text data to voice data and vice versa. Consequently, a disabled user can use the webpad to communicate regardless of whether the user has a hearing or speech impediment. The webpad can replace traditional text telephone (TTY) devices. The webpad can also include fingerprint recognition capability to allow a disabled user to readily enter a secured identification for authorizing electronic transactions.

### BRIEF DESCRIPTION OF THE DRAWINGS

The accompanying drawings illustrate various embodiments of the present invention and are a part of the specification. Together with the following description, the drawings demonstrate and explain various principles of the present invention. The illustrated embodiments are examples of the present invention and are not intended to limit the scope of the invention to any particular example illustrated.

FIG. 1 is an illustration of a first embodiment of a wireless internet/communication system for the hearing impaired according to the present invention.

FIG. 2 is a perspective view of a wireless internet/communication system for the hearing impaired according to an embodiment of the present invention.

FIG. 3 is a perspective view of a wireless internet/communication system for the hearing impaired according to an embodiment of the present invention.

FIG. 4 is a perspective view of an embodiment of a one-touch authorization system according to the present invention.

FIG. 5 is a perspective view of another preferred embodiment of a one-touch authorization system according to the present invention.

FIG. 6 is a flowchart illustrating a method of operating the system illustrated in FIG. 2 in accordance with another embodiment of the present invention.

FIG. 7 is a flowchart illustrating a method of operating the system illustrated in FIG. 2 in accordance with still another embodiment of the present invention.

FIG. 8 is a flowchart illustrating a method of operating the system illustrated in FIG. 3 in accordance with still another embodiment of the present invention.

FIG. 9 is a flowchart illustrating another embodiment of the present invention.

Throughout the drawings, identical reference numbers designate similar, but not necessarily identical, elements.

### DETAILED DESCRIPTION OF EMBODIMENTS OF THE INVENTION

In one embodiment, the present invention provides a multi-functional webpad for a disabled user. The webpad implements a method and provides a system that allows a user (with or without disabilities) to effect TTY communication with another party. The webpad may be defined herein and in the appended claims as an internet/communication device that may have various capabilities that including, but are not limited to: surfing the Internet, e-mailing, and remotely controlling other electronic devices to name a few.

Using the drawings, embodiments of the present invention will now be explained. FIG. 1 illustrates the elements that may be used in a TTY communication method for the disabled. In the figures shown, open arrows indicate the wireless transfer of data or control signals using, for example, radio frequency (RF) waves, infrared (IR), or other such methods of transferring information between electronic devices without the use of a physical connection. As used herein and in the appended claims, any such connection will be referred to as a wireless connection. The thin solid arrows represent electronic signals internal to the webpad (201).

A telephone interface (101) is shown in FIG. 1. A telephone interface or telco interface (101) as used herein may be any element that interfaces with a standard telephone line (100) and a webpad (201). In the present example, the telephone line (100) is capable of carrying conversations from a TTY device. As indicated above, TTY devices use a method of sending information, including text and numbers, using a signal similar to that of a computer modem. The TTY signal cannot be understood by a listening user without the aid of a TTY device to translate the signal back into the original text. The present invention may allow effective communication whether or not the other party has a device that is capable of translating and displaying a TTY encoded signal.

In one embodiment of the present invention, the telco interface (101) may be a wireless dongle. A dongle may be any mechanism or system for ensuring that only authorized users can use a specific software or hardware application. Dongle mechanisms include a hardware key that must be verified on an electronically linked device, a registration number communicated between two devices, or any other system that allows only a user with the dongle to operate a system or electronic device. The dongle essentially acts as a hardware password for an additional hardware or software application providing security to a user so that only an authorized user can access the user's phone line.

Additionally, the telco device (101) may be an interactive television (TV). The term “interactive television” or “interactive TV” as used herein and in the appended claims is defined as an interactive television set or regular television set and interactive set-top connected together. The interactive TV allows information or data transmitted and received over the telephone line (100) to be displayed on the graphical display that is an inherent part of the interactive TV. The telco device (101) may have the capability to translate a TTY signal to a text or voice form or may translate a voice message to a text or TTY form before further transmitting a signal. Additionally, the interactive TV may allow information to be recorded and interactive TV content to be displayed for user interaction. In the case that the interactive TV is connected to an internet connection, web browsing, e-mailing features, and other basic internet functionality of personal computers may be available.

The telco device (101) will preferably have access to a wireless local area network (WLAN) connection for the wireless transmission of signals between devices. A wireless LAN is one in which a mobile or roving user can connect to a local area network (LAN) through a wireless (RF) connection. The original Institute of Electrical and Electronics Engineers wireless-Ethernet specification or standard, known as IEEE 802.11, designated two ways of communicating between devices and allowed for speeds up to 2 Mbps. Both direct-sequence spread spectrum (DSSS) and frequency-hopping spread spectrum (FHSS) communications methods, each use the frequency-shift keying (FSK). DSSS and FHSS are based on spread-spectrum radio waves in the 2.4-gigahertz (GHz) range.

Spread spectrum and FSK allow data to be sent in small pieces over a number of the discrete frequencies available for use at any time in the specified range. Devices using DSSS communicate by splitting each byte of data into several parts and sending them concurrently on different frequencies. DSSS uses large amounts of the available bandwidth of a system, about 22 megahertz (MHz).

Devices using FHSS send a short burst of data, shift frequencies (hop) and then send another short burst. Since the FHSS devices that are communicating agree on which frequencies to hop to, and use each frequency for a brief period of time (less than 400 milliseconds) before moving on, several independent FHSS networks can exist in the same physical area without interfering with each other.

HomeRF (RF stands for radio frequency) is another type of wireless standard that may be used in the present invention. HomeRF uses a developed standard called shared wireless access protocol (SWAP). A sort of hybrid standard, SWAP includes six voice channels based on the Digital Enhanced Cordless Telecommunications (DECT) standard and the 802.11 wireless-Ethernet specifications for data. SWAP devices make 50 hops per second and transmit at 1 Mbps.

A wireless communication under the principles of the present invention may employ any of the standards and techniques mentioned or that are yet to be developed. Emerging wireless communication standards include IEEE standard 802.15 and Bluetooth technology.

FIG. 1 further illustrates a webpad (201) according to an embodiment of the present invention. The webpad (201) is preferably a wireless remote control device for an interactive TV or other teleco device (101). The webpad (201) also preferably provides enhanced features for accessing various digital media, including, for example, an internet connection available through the telco device (101). The webpad (201) has a wireless input/output interface (103) for sending or receiving a wireless, e.g., a WLAN, signal. As shown, the webpad (201) communicates wirelessly with the telco device (101) using the interface (103).

The webpad (201) includes a processor (108a) for signal processing and running software applications. The processor (108a) is the central processing unit (CPU) within the webpad (201) and may contain a memory system such as random access memory (RAM) (108b). Additionally, an operating system may be stored in the webpad (201) for execution by the processor (108a). The operating system coordinates the software tasks that are sent to the processor (108a). The processor (108a) and operating system coordinate the computing elements of the webpad (201) by allocating memory space, time for each process, and processing the application programs.

The webpad (201) preferably employs various application programs for processing the various types of signals that may be sent or received. In one example, the teleco device (101) wirelessly transmits a signal carrying a voice, e.g., a telephone conversation. If the signal received by the webpad (201) carries a voice, the signal may be converted to a text file, such as an American Standard Code for Information Interchange (ASCII) file, by a speech to text software application (105a).

The character codes used by ASCII may be particularly useful in the webpad (201) because ASCII is the most common format for text files in computers, word processing programs, and other electronic devices. In an ASCII file, each alphabetic, numeric, or special character is represented with a 7-bit binary number. ASCII files are easily stored in RAM (108b) and processed by the processor (108a) for display purposes.

If the signal received from the telco device (101) is text in a TTY format, the TTY encoded signal is similarly converted to an ASCII text file by a TTY signal to text application program (105b). The converted, incoming text may be displayed by the processor (108a) on a display device (e.g., 110) of the webpad (201). In this manner, TTY messages are easily translated and displayed for quick user response.

Additionally, a text to speech application program (106) may be available on the webpad (201), allowing TTY, ASCII, or other text to be converted into a voice signal. A voice signal is defined as any signal, human or computer generated, that is intelligible as coherent speech in a user's native language when output through a speaker (113). If the webpad (201) converts text into a voice signal, that voice signal can then be output and rendered audible through a speaker (113).

Preferably, the webpad (201) also includes a microphone (114) to facilitate the user in communicating with another party through the webpad (201). The speaker (113) may be used in conjunction with the text to speech application program (106) allowing the received signals to be audibly rendered for a listening user. The microphone (114) may allow the user's voice to be input into the webpad (201) as an electronic signal for conversion to a TTY, ASCII or other text file, or for direct transfer to another party. Using the speaker (113), microphone (114), and display (110), a user can use the webpad (201) to communicate with another user who may or may not be using a TTY device or a similar webpad.

A user interface (111) allows a user to control and interact with the webpad. The user interface is preferably a graphical user interface (GUI) displayed on and including a display (110) for displaying messages and allowing the user to control the webpad (201). The GUI (111) also preferably includes various menus, icons or other devices that allow a user to control the webpad (201) and invoke webpad functions.

As used herein the display (110) may be any of a liquid crystal display (LCD) screen, light emitting diode (LED) display, cathode ray tube (CRT) or any other displaying element that allows an incoming or outgoing signal to be visually displayed.

The display is preferably a touch screen display (110). A touch screen display is preferred because it is lightweight and allows the webpad (201) to be handheld device. Also, the touch screen allows for data to be displayed and for the user to interact with that data in very ready and intuitive fashion. Alternatively, the user interface controlling elements could include a mouse, trackball, Braille keypad, light pen, or any other mechanism that allows the user to input information or control the webpad.

In particular, a GUI (111) works well on a touch screen display (110). A GUI (111) (rather than a purely textual interface) allows a user to interactively interface with the webpad (201) using the touch-sensitive nature of the display to select displayed options and enter commands. A GUI (111) may display graphical elements such as: windows, pull-down menus, buttons, scroll bars, iconic images, and/or wizards. As any of the above mentioned GUI elements are selected or touched on the touch screen display (110) that action is converted to a command or character to be entered on the webpad (201).

A GUI (111) may allow the user to advantageously view or enter information to be sent or received. In the present invention, the GUI (111) may be able to display a virtual alphanumeric keyboard on the touch screen display (110). The alphanumeric keyboard displayed by the GUI (111) may function as a normal keyboard in allowing a user to enter text characters or numbers used in a normal conversation. As the user touches each character graphically displayed on the display (110) the corresponding character may be displayed and entered on to the webpad for use in the communication session.

A driver is a program that interacts with a particular device or special kind of software application program. The driver contains the special knowledge of the device or software interface that programs using the driver do not. The webpad (201) may have various drivers.

An included video driver (109) takes the general instructions received from the processor and converts them to messages and signals that the can be readily used in the GUI (111) and displayed on the display (110).

Similarly, an interface driver (107) may receive user input entered through the user interface (111) and convert that data into a signal that can be used by the processor (108a). The user input may then be echoed or an appropriate response displayed on the display (110).

An external alphanumeric keyboard (112) may be able to communicate with the webpad (201) through the wireless input/output interface (103) previously described, or through a wired connection (not shown). Preferably the external alphanumeric keyboard (112) has an output interface for sending characters and control signals to the webpad (201). This may allow a user to use a full-scale physical keyboard (112) to enter messages for the other party of the communication session. The characters received from the external keyboard (112) may be sent to the webpad (201) (and/or telco device (101)) and thereon displayed.

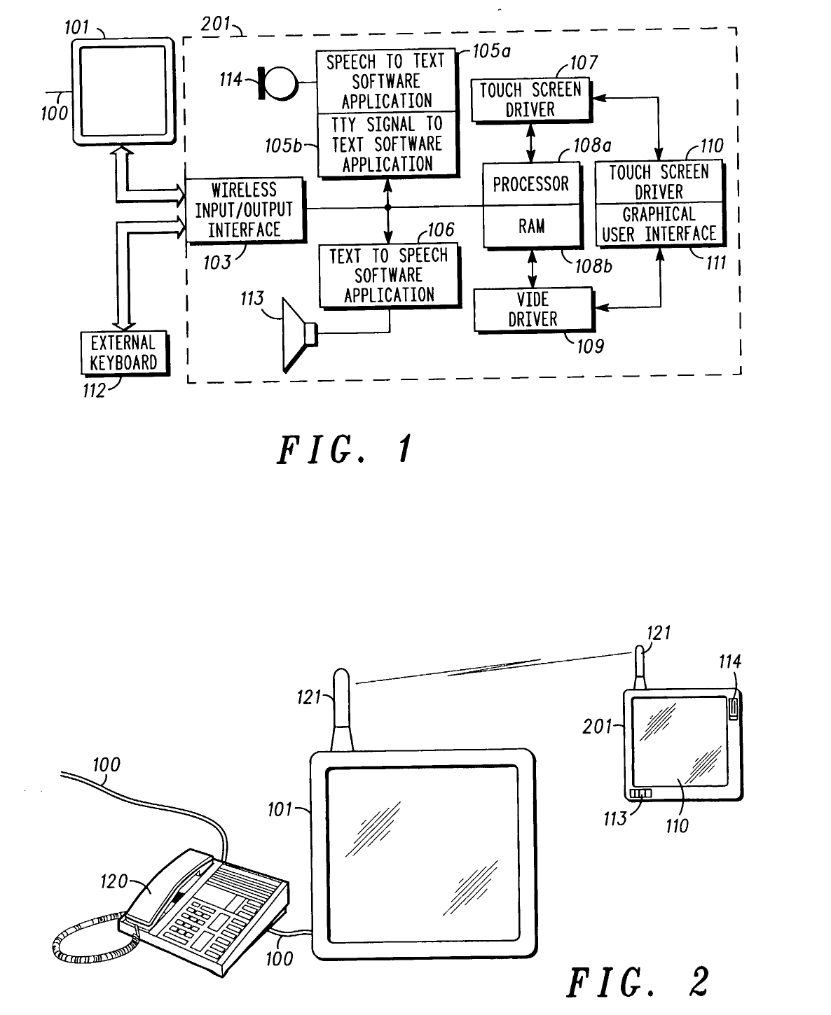

FIG. 2 illustrates a telephone (120), telco device (101), and webpad (201) in one embodiment of a wireless internet/communication system for the disabled according to principles of the present invention. A redundant explanation of system components already described above will be omitted in describing FIGS. 2, 3, 4 and 5.

A telephone (120) may be connected to a phone line (100) as shown in FIG. 2. The telephone (120) is preferably a standard telephone as is the phone line (100). The phone line (100) is preferably connected to the telephone (120) and continues on to the telco device (101). As previously described, the telco device (101) and webpad (201) are equipped with wireless communication functionality. The telco device (101) and the webpad (201) may transmit data wirelessly as described above. The information may be transmitted wirelessly from each device using a wireless antenna (121). The transmitting device or wireless antenna (121) may be any device that transmits and receives a wireless signal and interfaces with the wireless input/output interface.

FIG. 3 illustrates another embodiment of the wireless internet/communication system for the disabled according to the present invention. In FIG. 3, the telco device (101) is connected to a telephone line (100) through a standard cordless telephone base unit (132). The cordless phone and base unit (132) are preferably able to operate in a standard manner in conjunction with the present invention.

In the present embodiment, the telco device (101) is preferably connected to a high-speed internet connection (131). This may allow the telco device (101) and webpad (110) to have added functionality, i.e. the user may be able to surf the internet using the webpad (201). The high-speed internet connection (131) may be any of a fiber optic, Ethernet, DSL, satellite, cable or any other connection that allows the transfer of data. Because of the possibility that the telco device (101) is an interactive TV, the high-speed internet connection will hereafter be referred to as a cable connection (131).

The telco device (101) may be equipped with a cable modem (132) either internally or externally. The cable modem (132) allows the telco device (101) to connect to the internet using a cable connection (131) that has a specified bandwidth for internet connectivity. In most cases, a cable connection (131) and cable modem (132) allows data to be transferred over a standard coaxial cable television line at a rate much higher than a standard dial-up connection. The cable connection (131) may allow the telco device (101) and webpad (201) to display, transfer, and search available information from the internet.

As previously mentioned, an external keyboard (112) may be used to input text and/or other characters to the webpad (110 and/or telco device (101)). The external keyboard (112) and webpad (110) are preferably equipped with a wireless antenna (121) allowing each device to operate from various different locations within a room or building.

In addition to transmitting to the telco device (101), the webpad (110) of FIG. 3 may be able to transfer a TTY signal, voice signal, or other signal directly to the cordless telephone base unit (132). The base set of a cordless phone typically receives a signal from a standard telephone line (100) and converts it to a frequency-modulated signal for broadcasting to the handset. Frequency modulation (FM) is a method of impressing data onto an alternating-current wave by varying the instantaneous frequency of the wave. Modern cordless phones typically use a frequency protocol of 900 MHz or 2.4 GHz, and transmit the signal to the handset (or receiver) of the cordless phone.

Preferably, the webpad (110) is capable of ‘learning’ the communication protocol of a cordless base set (132). This will allow the webpad (110) to transmit a signal directly to the phone (132). Learning the communication protocol may require the webpad (110) to learn the frequencies and frequency modulation patterns used by the cordless base set (132) to transmit and receive signals from the handset. The webpad (110) may then act as a cordless receiver in sending a signal to, and receiving a signal from, the cordless base set (132). Consequently, the present embodiment may allow a user to carry on a TTY or other conversation using only the webpad (201) and cordless phone base set (132).

FIG. 4 illustrates a webpad (201) incorporating a touch screen display (110) and is used to show a first preferred embodiment of a one-touch authorization system according to the present invention. The touch screen display (110) may allow a user to control information accessed from the webpad (201) by prompting the user with the GUI (111). Additionally, the touch screen display (110) unit may receive a fingerprint (140) in order to identify a user and/or authorization level. As defined herein and in the appended claims, a fingerprint (140) is the impression of any fingertip or human digit wherein the impression is the indentations, deformities, grooves, and lines unique to each digit of an individual.

The touch screen display (110) may receive the fingerprint in a number of ways including: scanning, infrared sensing, or any other method that can distinguish the individual characteristics of a fingerprint (140). By reading and identifying a fingerprint (140) the touch screen display (110) allows a user to use a fingerprint as a password or system authorization tool. The webpad (201) may allow a user to link a fingerprint (140) with an authorization code or password stored on the memory of the webpad (201), on-line, or on the telco device.

For example, the user may have programmed an authorization level or parental control for the interactive television in the home. The fingerprint (140) reading feature of the webpad (201) may allow an authorized user to initiate the transmission of a restricted program by providing a user specific fingerprint (140). Users without the required authorization would subsequently be denied access if they input their fingerprint (140) on the touch screen display (110). This system allows authorized users to secure the desired functions carried out on the webpad (201) and webpad-linked devices.

The fingerprint (140) system may also allow a user to order an item or program from an interactive television or from a web-site by linking the fingerprint (140) with a user profile stored on the webpad (201). For example, if the user wishes to purchase a pay-per-view program over the interactive television, or if the user wishes to order an item offered from sale on an internet site, the user authorize the purchase, under principles of the present invention, by entering his or her fingerprint. The user profile associated with that fingerprint will include, for example, credit card number, password, age, address, and/or other information required for completing the desired transaction. The present invention would eliminate the need for a user to enter a password or call a service operator in making a transaction while simultaneously maintaining a stringent security system. In the case of a disabled user, the one-touch system allows a user to provide a required authorization without speaking with an operator or requiring excessive typing or other movement. Various users may have different authorization levels and user profiles linked with each specific fingerprint.

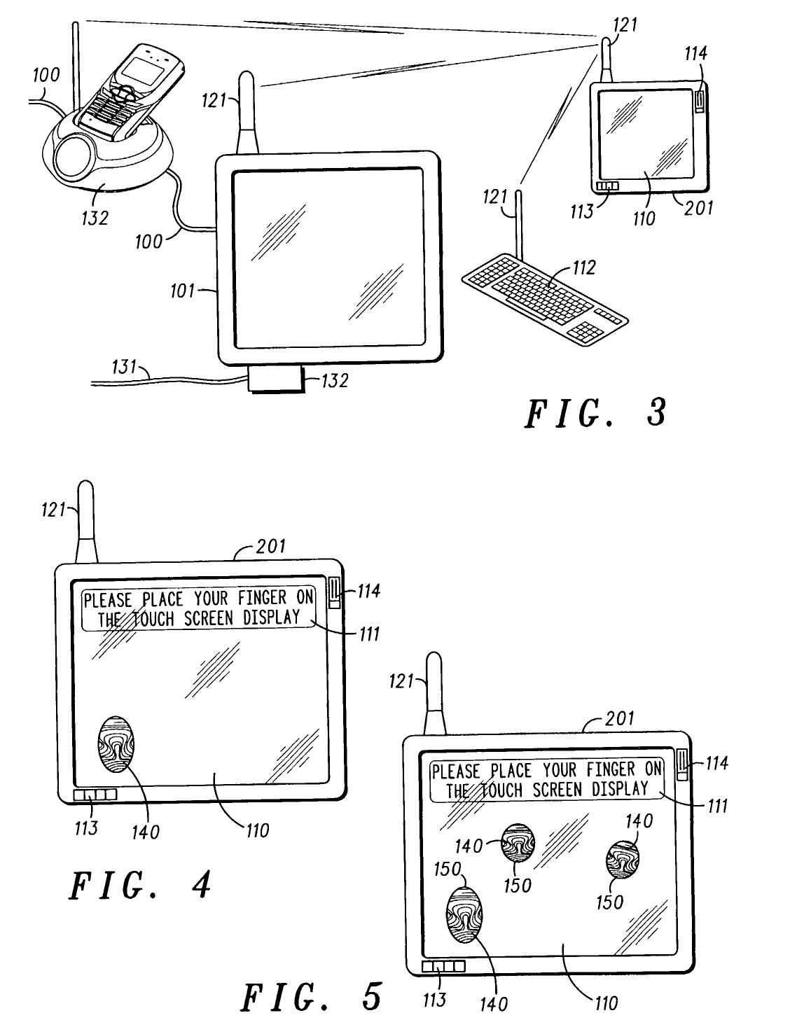

FIG. 5 illustrates an additional embodiment of the use of the webpad (201) in a one-touch authorization system. The touch screen display (110) may allow a user to input a fingerprint(s) (140) in one or more geographic locations on the touch screen display (110) as a form of password or authorization as previously described. The fingerprint(s) and corresponding locations on the touch screen display (110) will hereafter be referred to as the fingerprint configuration (150).

In the present embodiment, the touch screen display (110) may recognize the fingerprint configuration (150), fingerprint(s) (140) and/or impression size to verify user identity and authorization. The fingerprint configuration (150) may have a ‘hot-spot’ or assigned position on the touch screen (110) for each fingerprint (140) that must be touched in order to grant authorization or access. Unless the fingerprint configuration (150) is input substantially as expected by the programmed ‘hot-spot’ configuration, access will be denied.

In one example, an authorized user may input a fingerprint configuration (150) on the touch screen display (110) of the webpad (201) in order to verify identification for ordering a new cable channel or a pay-per-view event on an interactive TV.

Even if an unauthorized user were able to input the fingerprint configuration (150), the fingerprint impression size or other fingerprint (140) characteristics would not match up to grant authorization. Different authorization levels or passwords may be used with different fingerprint configurations (150) to make a one-touch system even more secure. For example, a simple fingerprint configuration (150) may be linked with ordering a pay-per-view movie while a more complex fingerprint configuration (150) may allow the user to enact a transaction using a credit card.

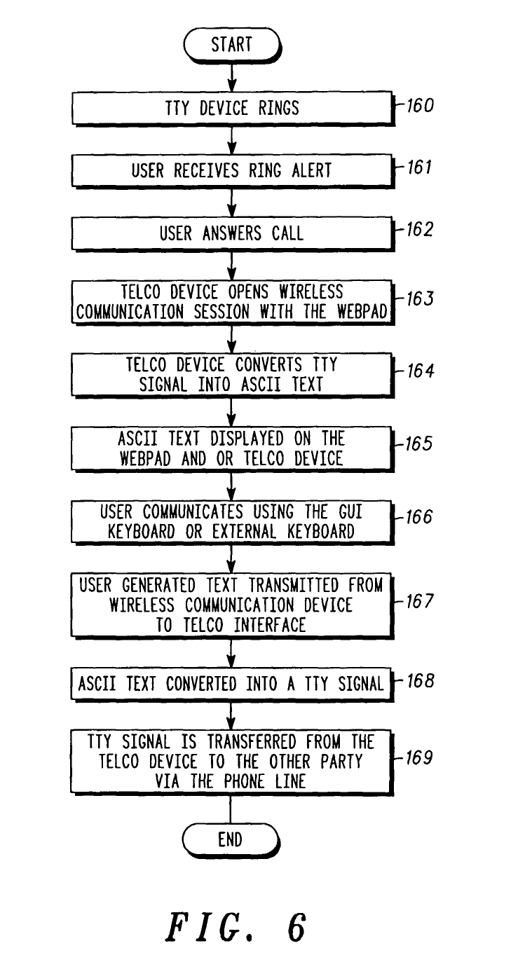

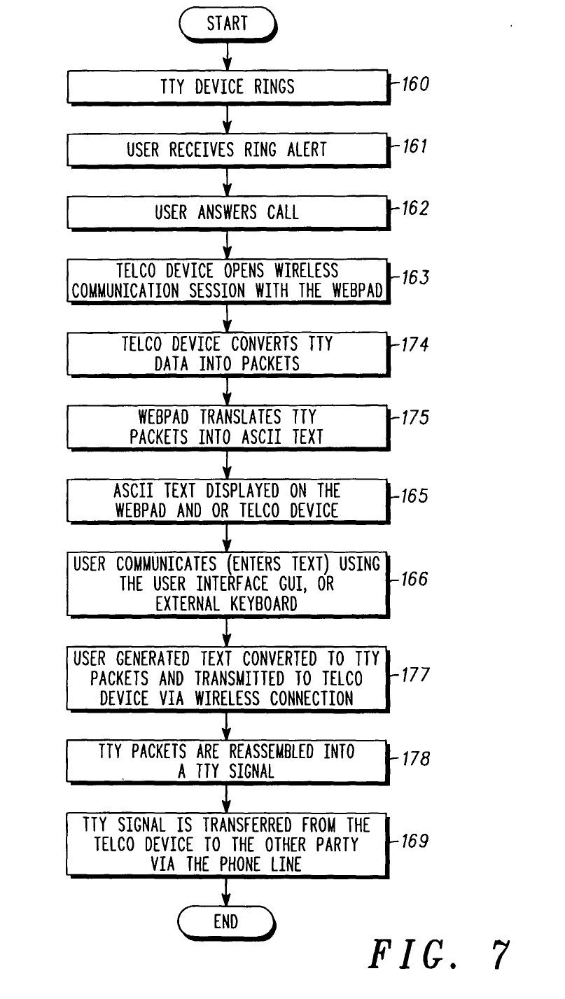

FIG. 6 is a flow chart illustrating a preferred method of operating the system illustrated in FIG. 2 in accordance with principles of the present invention. The processes shown in FIGS. 6, 7, and 8 are for receiving a call, TTY or otherwise. To initiate a call, one party simply dials the phone number necessary to reach the other party using either the telco device or the webpad as previously described. As shown in the example of FIG. 6, the process may begin as a user receives a call and the telephone rings (160). The present invention may be particularly useful for those with disabilities that may be unable to hear or distinguish the ring of a telephone (160). In such a case, the telco device and/or webpad may generate a visual alert, such as flashes on the display device, vibrate, or perform other alert function so that the user might be made aware (161) of the incoming telephone call.

The user may subsequently answer the call (162) using the teleco device, or the webpad. If the webpad is used, a wireless connection may be established between the telco device and the webpad (163). The communications session may be established such that during the phone call or TTY communication the telco device and wireless connection device may send and receive signals simultaneously. The communication session may allow a dedicated amount of available bandwidth and priority level to be allotted between the webpad and telco device insuring reliable and fast transmission of data. During the established communications session (163), the webpad or the teleco device translates the TTY signal into ASCII text (164). ASCII text is preferable because of its nearly universal application in electronic devices. This will allow the telco device and/or the webpad to display the text on each display.

The user may desire to respond to the calling party as the TTY communication session continues. A user may communicate using the user interface of the webpad, including, for example, a GUI keyboard on the touch screen display or an external keyboard (166). The user-generated text is preferably transmitted to the telco device via the established wireless connection (167). The telco device and the webpad may display the user-generated text as it is typed (166) in order to help the user know what has been communicated by each user. Once the ASCII text is received by the telco device (167), the text may be converted into a TTY signal and transferred to the other party over the phone line (168). Alternatively, the webpad may convert the entered text to the TTY format before transmitting the message to the telco device. In this manner a TTY conversation may be carried on even though the user does not have a tradition text telephone.

An alternative method of operating the system illustrated in FIG. 2 is shown in FIG. 7. The method illustrated in FIG. 7 is similar to that illustrated and described above in connection with FIG. 6. Therefore, a redundant explanation of method steps already described above will be omitted in describing FIG. 7. The process may begin when the webpad, teleco device, or telephone (160) signals an incoming call (160) and continues as previously described. After the telco device has opened a wireless communication session with the webpad, the telco device may translate the incoming TTY signal into TTY packets (174). TTY packets may be portions of the TTY transmission signal divided into packets (174) in order to facilitate the wireless transmission of the TTY data between the telco device and the webpad.

The webpad may begin to convert the packetized TTY data received by the webpad (175) into ASCII text. After the user has typed a portion of a conversation using the GUI keyboard displayed on the touch screen display, external keyboard or other user interface device (166). The text may be converted to TTY packets and transmitted to the telco device via the wireless communication session (177). Once the outgoing TTY packets are received by the teleco device, the TTY packets are preferably converted to the standardized TTY data signal (178). Once the signal is converted to a TTY data stream (178) the signal may be transmitted to the other party over the telephone line (169). The telco device and/or webpad may have a buffering and sensing capability further enhancing the TTY communication session that allows only one user to send information at a time. A message typed by the user would be stored in the buffer until the message could be manually or automatically sent to the other user.

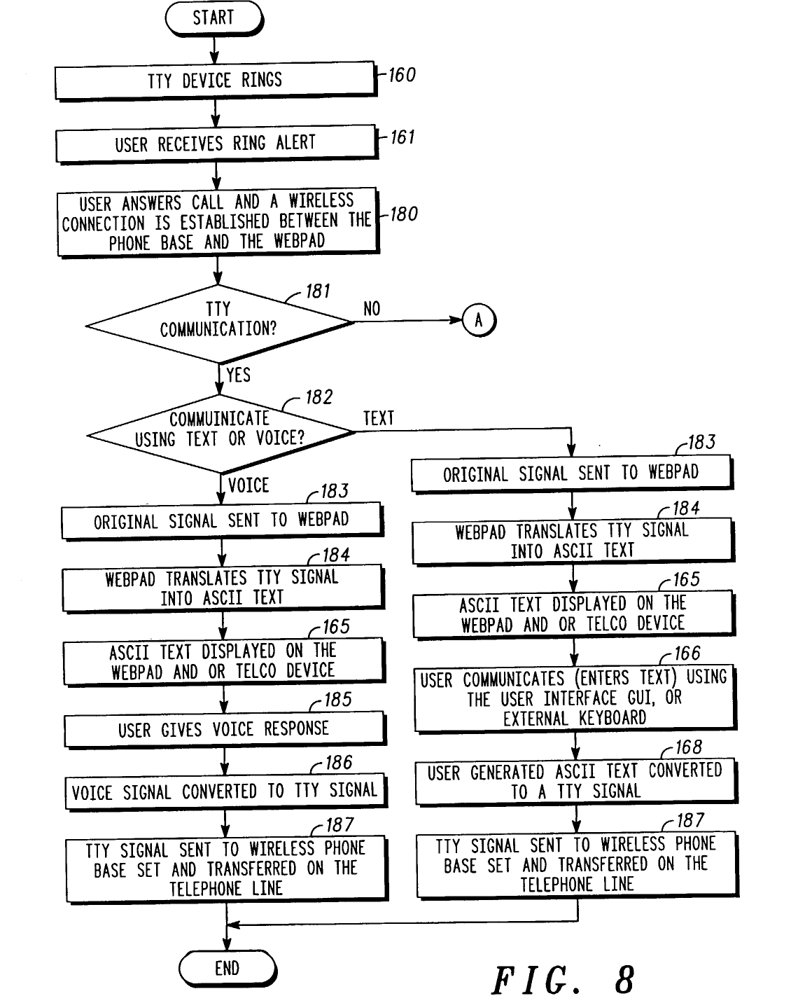

FIG. 8 is a flow chart illustrating a preferred method of operating the system illustrate in FIG. 3 in accordance with principles of the present invention. A redundant explanation of method steps already described above will be omitted in describing FIG. 8. The process may begin when an incoming call causes the telephone, webpad and/or teleco device to signal receipt of an incoming call. As described above, the user becomes aware of the incoming call due to the visual and/or audible signaling. The user may answer the call by establishing a wireless connection between the wireless phone base set and the webpad (180).

As previously described, the webpad may be able to learn the wireless protocol of a cordless phone allowing the two to easily transmit a signal as if the webpad were the handset of the cordless phone unit. The webpad or the user may then decide whether or not the incoming call is a TTY communication (181) at which time the user may choose to communicate in text or voice (182). If the call is a TTY communication (181) and the user chooses to give a voice response (182), the incoming TTY signal is transferred to the webpad (183).

The webpad may then translate the TTY signal into ASCII text (184). The ASCII text is then preferably displayed on the webpad and/or telco device (165) so that the user can read the incoming TTY signal. In addition to displaying the text on the webpad, the webpad may also allow the translated signal to be converted by a text-to-voice application program and audibly rendered or ‘read’ on a speaker so that the user can listen to what the other party is writing as the signal is received.

As the user receives the displayed message (165) it may be possible to give a voice response (184). The voice response given may be received by the microphone and converted to a TTY signal (185) at which time it may be transferred to the wireless base set and transferred to the other party on the telephone line (186). This system thus allows a user to respond to a TTY phone call without using the TRS.

If a TTY signal is verified (181) and the user desires to communicate using the GUI keyboard or external keyboard to enter a text message (182), the process may similarly begin as the webpad translates the TTY signal into ASCII text (183). The ASCII text may be displayed (165) and the user may communicate (166) after which time the ASCII text may be converted to a TTY signal (168). The TTY signal may then be sent to the wireless phone base set and transferred on the telephone line (186).

If the user or webpad determines that the phone call is not a TTY communication (181), the user may similarly choose to communicate using text or voice (182). If the user decides to communicate using voice, the original signal is sent to the webpad (183). The message received from the cordless telephone base set by the webpad (183) may be output by the speaker of the webpad (165b). The user may speak and the voice signal may be received by the webpad microphone and sent to the wireless phone base set (189). The voice signal may then be transferred to the other party over the telephone line (190). This application may allow a user to use the webpad as a cordless phone handset in addition to the other applications previously mentioned.

If the call is not a TTY communication (181) and the user elects to communicate using text (182). The signal may be received from the cordless telephone base set by the webpad (183). The received voice signal is converted to ASCII text (188). The ASCII text may then be displayed (165) and the user may communicate with the other party using the GUI keyboard and/or external keyboard (166). The user-generated text may then be translated to a voice signal by the webpad (189). The voice signal may subsequently be transferred from the webpad to the cordless phone base set (191) or to the telco device. Afterwards, the speech signal may be transmitted via the telephone line (190). This process may similarly allow a disabled user to receive normal voice calls without using a dedicated TTY device or the TRS.

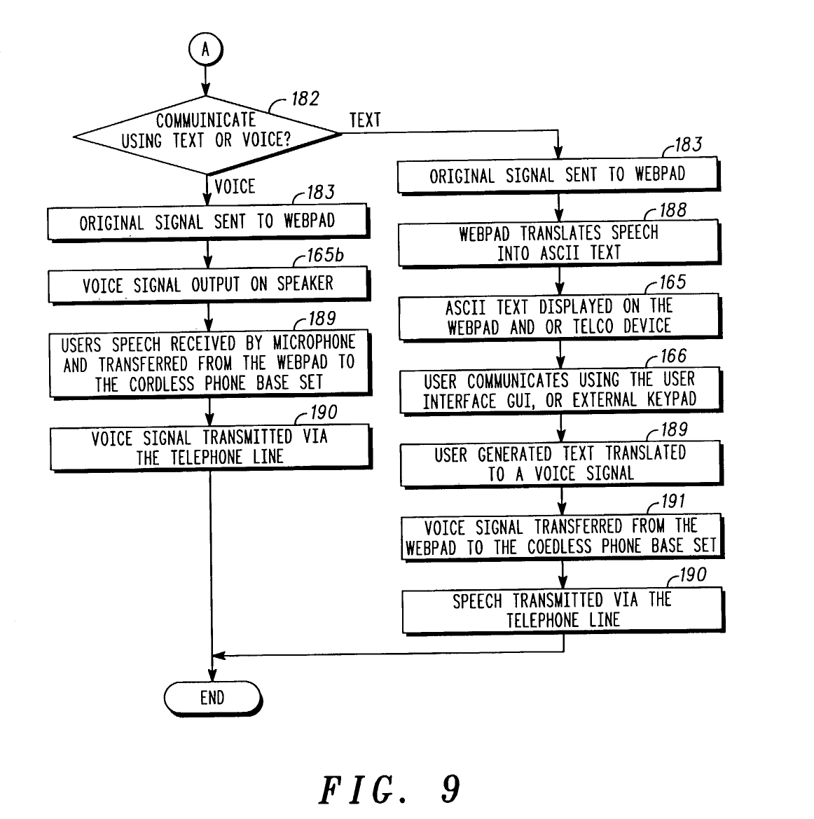

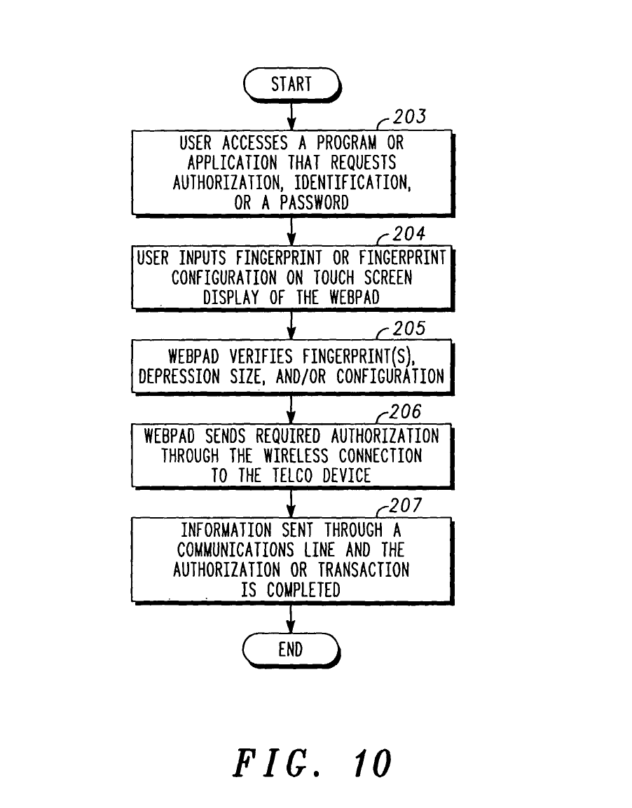

FIG. 9 is a flow chart illustrating a preferred method of operating the system illustrate in FIGS. 4 and 5 in accordance with principles of the present invention. The method begins when a user accesses a program or application that requests authorization, identification, payment information, or a password (203). Instead of inputting personal information, the user may simply input a fingerprint or fingerprint configuration (204).

A touch screen display or other electronic fingerprint reader may receive the fingerprint in a number of ways including scanning, infrared sensing, or any other method that can distinguish the individual characteristics of a fingerprint as previously described. The webpad may then verify the fingerprint(s), depression size, and/or configuration (205) to link with a specific user. If the fingerprints represent an authorized user, the webpad may then send the required authorization through the wireless connection to the telco device (206). Information may then be sent through a communications line to the authorizing entity and the authorization or transaction is completed (207).

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best illustrate the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A webpad for textual and vocal communications comprising:
a processor;
a user interface in communication with said processor for control operation of said webpad;
a memory unit for storing application programs for execution by said processor;
an application program stored in said memory unit for converting data between a text form and a voice signal form; and
a wireless input/output interface, connected to said processor, for sending and receiving signals.

2. The webpad of claim 1, further comprising:
a microphone for generating a voice signal; and
speaker for rendering a voice signal audible.

3. The webpad of claim 1, wherein said wireless input/output interface comprises an antenna.

4. The webpad of claim 1, wherein said wireless input/output interface transmits and receives a radio frequency signal.

5. The webpad of claim 1, wherein said wireless input/output interface transmits and receives a infrared signal.

6. The webpad of claim 1, wherein said input/output interface transmits to and receives a signal from a telco device.

7. The webpad of claim 6, wherein said telco device is any of an interactive television, a dongle, an internet appliance, a cordless telephone, or a telephone line.

8. The webpad of claim 6, wherein said telco device is connected to any of an Ethernet, fiber optic, cable television, or telephone line.

9. The webpad of claim 1, wherein said input/output interface learns the communication protocol of a cordless phone base set.

10. The webpad of claim 1, wherein said input/output interface is configured to receive a signal from an external keyboard.

11. The webpad of claim 1, wherein said user interface comprises a touch screen display.

12. The webpad of claim 11, wherein said user interface further comprises a graphical user interface displayed on said touch screen display.

13. The webpad of claim 12, wherein said graphical user interface displays a virtual keyboard, graphical control elements or other elements for entering and controlling a text message.

14. The webpad of claim 1, wherein said application program is configured to convert any of a text telephone (TTY) signal, text, or a voice signal in to any of a TTY signal, text, or a voice signal.

15. The webpad of claim 1, further comprising circuitry for remotely controlling a television set through said wireless input/output interface.

16. A method of text and voice communication, said method comprising:
receiving an incoming signal from a telco device with a webpad;
communicating said incoming signal to a webpad user;
receiving input from the user through a user interface of said webpad; and
transmitting said input as an outgoing signal to said telco device.

17. The method of claim 16, wherein said incoming signal is a voice signal, said method further comprising outputting said incoming voice signal through a speaker of said webpad.

18. The method of claim 16, wherein said incoming signal is a text signal, said method further comprising:
converting said text signal into a voice signal; and
outputting said voice signal through a speaker of said webpad.

19. The method of claim 16, wherein said user interface comprises a microphone and said receiving input further comprises transducing a user's speech into a voice signal.

20. The method of claim 19, further comprising transmitting the transduced voice signal to said telco device as said outgoing signal.

21. The method of claim 19, further comprising:
converting said transduced voice signal into a text signal; and
transmitting that text signal to said telco device as said outgoing signal.

22. The method of claim 21, further comprising converting said transduced voice signal into a text telephone (TTY) signal.

23. The method of claim 21, further comprising converting said transduced voice signal into a American Standard Code for Information Interchange (ASCII).

24. The method of claim 16, wherein said receiving an incoming signal and said transmitting an outgoing signal comprises receiving or transmitting a radio frequency signal.

25. The method of claim 16, wherein said receiving an incoming signal and said transmitting an outgoing signal comprises receiving or transmitting an infrared signal.

26. The method of claim 16, wherein said telco device comprises a cordless phone and said method further comprises learning a wireless communication protocol of a base set of said cordless telephone.

27. A webpad for text and voice communication, said webpad comprising;
processing means for executing an application program to provide webpad functionality;
user interface means for controlling said webpad, outputting an incoming signal and receiving user input;
storage means for storing said application program; and
wireless communication means for sending and receiving wireless signals comprising said incoming signal and an outgoing signal;
conversion means for converting said data carried by said signals between a text form and a voice form.

28. The webpad of claim 27, wherein said wireless communication means send and receive radio frequency signals.

29. The webpad of claim 27, wherein said wireless communication means send and receive infrared signals.

30. The webpad of claim 27, further comprising means for learning a communication protocol of a cordless phone base set.

31. The webpad of claim 27, further comprising means for receiving a signal from an external keyboard.

32. The webpad of claim 27, wherein said user interface means further comprise means for inputting a voice signal.

33. The webpad of claim 27, wherein said user interface means further comprise means for inputting a text message.

34. The webpad of claim 27, wherein said user interface means further comprise means for displaying graphical information including a web page.

35. The webpad of claim 27, wherein said user interface means further comprise a touch screen display.

36. The webpad of claim 27, wherein said conversion means comprises means convert any of a text telephone (TTY) signal, text, or a voice signal in to any of a TTY signal, text, or a voice signal.

37. An access control system for disabled individuals comprising:
a handheld remote control device comprising:
a sensor for receiving at least one user fingerprint; and
a wireless input/output interface for sending and receiving signals; and
a telco device communicating wirelessly with said remote control device;
wherein, upon identification of a user using said fingerprint, said remote control device transmits authorization for an electronic transaction to said telco device with said wireless input/output interface.

38. The access control system of claim 37, further comprising circuitry for remotely controlling a television set through said wireless input/output interface.

39. The access control system of claim 37, wherein said sensor comprises a touch screen display.

40. The access control system of claim 39, further comprising a graphical user interface displayed on said touch screen display for offering a user input options.

41. The access control system of claim 37, wherein said wireless input/output interface transmits and receives radio frequency signals.

42. The access control system of claim 37, wherein said wireless input/output interface transmits and receives infrared signals.

43. The access control system of claim 37, wherein said teleco device is connected to any of a fiber-optic, cable television, telephone, or Ethernet line.

44. The access control system of claim 37, wherein said sensor comprises a scanner, touch sensor, or infrared sensor for receiving said user fingerprint

45. A method of authorizing an electronic transaction with a webpad, said method comprising:
reading a user fingerprint with a sensor on a handheld remote control unit;
identifying said user based on said fingerprint;
granting authorization an electronic transaction based on said user fingerprint; and
transmitting said authorization to a telco device and over a communications line connected to said telco device.

46. The method of 45, wherein said identifying said user passed on said fingerprint further comprises comparing a user profile containing fingerprint data with said fingerprint entered through said sensor.

47. The method of 46, wherein said user profile comprises a credit card number for transmission as part of said authorization.

48. The method of 45, wherein reading a user fingerprint further comprises further comprising sensing one or more user fingerprints in a predetermined configuration, wherein said step of identifying a user fails if said configuration of fingerprints does not match a predetermined configuration.
